(19) United States
(12) Patent Application Publication
(10) Pub. No.: US 2008/0047971 A1
(43) Pub. Date: Feb. 28, 2008

(54) Sticky Note Feeder and Sticky Note Printer

(75) Inventors: Hideki SAKANO, Matsumoto-shi (JP); Hiroyasu KURASHINA, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/838,703

(22) Filed: Aug. 14, 2007

(30) Foreign Application Priority Data
Aug. 25, 2006 (JP) 2006-229800

(51) Int. Cl. B65C 11/02; B65H 1/00

(52) U.S. Cl. 221/282; 221/2; 221/210

(57) ABSTRACT

A sticky note feeder includes: a casing; a discharge slot provided on the casing, to which slot a sticky note having an adhesive portion at one end of the back surface is sent; a feeding unit which sends the sticky note to the discharge slot along a feeding path; and a sticky note holding portion which holds the sticky note sent by the feeding unit such that the back face of the sticky note faces to below and that the end of the sticky note where the adhesive portion is not provided is exposed through the discharge slot. The sticky note holding portion is disposed on the upstream side of the discharge slot in the feeding direction at such a position as to face the feeding path from below.

The entire disclosure of Japanese Patent Application No. 2006-229800, filed Aug. 25, 2006, is expressly incorporated by reference herein.

### BACKGROUND

1. Technical Field

The present invention relates to a sticky note feeder which supplies a sticky note by sending the sheet to a discharge slot provided on a casing of the sticky note feeder, and a sticky note printer including the sticky note feeder.

2. Related Art

This type of sticky note feeder in related art separates a sticky note one by one from a bundle of sticky notes set on the sticky note feeder and sends the separated sticky note to a discharge slot formed on a casing of the sticky note feeder to supply the sticky note to a user (see JP-A-2003-212367).

When the separated sticky note drops to the outside of the sticky note feeder from the discharge slot, there is a possibility that dust or the like adheres to the adhesive portion of this sticky note, as well as the necessity for the user to take up the sticky note. In order to prevent dropping of the sticky note from the discharge slot to the outside of the sticky note feeder, one of the solutions is that a sticky note receiver, such as a sheet discharge tray of an ordinary sticky note printer, is provided on the feeder outside the discharge slot.

According to this structure, however, the sticky note receiver equipped outside the discharge slot to prevent dropping of the sticky note projects from the entire structure of the sticky note feeder. Thus, the overall size of the sticky note feeder increases.

### SUMMARY

It is an advantage of some aspects of the invention to provide a sticky note feeder capable of keeping a supplied sticky note at a discharge slot without increasing the overall size of the sticky note feeder, and a sticky note printer including the sticky note feeder.

A sticky note feeder according to a first aspect of the invention includes: a casing; a discharge slot provided on the casing, to which port a sticky note having an adhesive portion at one end of the back surface is sent; a feeding unit which sends the sticky note to the discharge slot along a feeding path; and a sticky note holding portion which holds the sticky note sent by the feeding unit such that the back face of the sticky note faces to below and that the end of the sticky note where the adhesive portion is not provided is exposed through the discharge slot. The sticky note holding portion is disposed on the upstream side of the discharge slot in the feeding direction at such a position as to face the feeding path from below.

According to this structure, the sticky note exposed through the discharge slot does not drop to the outside of the sticky note feeder but remains at the discharge slot without necessity for providing the sticky note receiving portion outside the discharge slot. In addition, since the sticky note holding portion is disposed on the upstream side of the discharge slot, that is, inside the casing, the overall size of the sticky note feeder does not increase.

In this case, it is preferable that the feeding unit has a feed roller which faces the feeding path and contacts the sticky note while rotating to send the sticky note, and that a distance between the feed roller and the sticky note holding portion is shorter than the length of the adhesive portion in the feeding direction.

According to this structure, the adhesive portion of the sticky note always reaches the sticky note holding portion by the time when the feed roller completes sending of the sticky note. Accordingly, the sticky note holding portion securely holds the sticky note by the adhesion of the adhesive portion.

In this case, it is preferable that the discharge slot has a sticky note receiving portion on the downstream side in the feeding direction such that the sticky note receiving portion extends to the outside of the casing.

According to this structure, the sticky note receiver assists the sticky note holding portion in holding the sticky note in such a case where the sticky note cannot be supported only by the sticky note holding portion, thereby securely preventing drop of the sticky note. Since the sticky note receiving portion only receives the end of the sticky note for holding the sheet as assistance, the sticky note receiving portion need not be large-sized. Accordingly, the overall size of the sticky note feeder does not increase.

In this case, it is preferable that the combined length of the sticky note holding portion and the sticky note receiving portion is shorter than the length obtained by subtracting the length of the adhesive portion from the entire length of the sticky note in the feeding direction.

According to this structure, the end of the sticky note held by the sticky note holding portion projects from the downstream end of the sticky note receiving portion to the downstream side. Thus, the user can easily pick up the sticky note held in this condition, and can easily take out the sticky note from the discharge slot.

In this case, it is preferable that the sticky note holding portion and the sticky note receiving portion are formed integrally with each other.

According to this structure, since the sticky note holding portion and the sticky note receiving portion are provided integrally with each other, construction of these components can be simplified. Accordingly, the production efficiency of the sticky note feeder improves.

A sticky note printer according to a second aspect of the invention includes the sticky note feeder described above, and a printing unit which executes printing on the surface of the sticky note sent by the feeding unit.

According to this structure, a printed sticky note in high quality condition can be supplied with the compactness of the printer maintained by using the sticky note feeder capable of keeping the sticky note sent to the discharge slot thereat without increasing the overall size of the sticky note feeder.

### BRIEF DESCRIPTION OF THE DRAWINGS

The invention will be described with reference to the accompanying drawings, wherein like numbers refer to like elements.

FIG. 1 is a perspective view schematically illustrating a sticky note printer according to an embodiment of the invention.

FIG. 2 schematically illustrates the interior of the sticky note printer according to the embodiment.

FIGS. 3A to FIG. 3F illustrate a series of operations performed by the sticky note printer.

FIG. 4 illustrates a structure of a discharge slot and its surroundings of the sticky note printer.

FIG. 5 illustrates the structure of the discharge slot and its surroundings at the time of receiving a free end of a sticky note by a sticky note receiving portion.

FIG. 6 illustrates the structure of the discharge slot and its surroundings, the lengths of which are compared with the lengths of the sticky note.

### DESCRIPTION OF EXEMPLARY EMBODIMENT

A sticky note printer including a sticky note feeder according to an embodiment of the invention is hereinafter described with reference to the appended drawings. This sticky note printer separates a sticky note one by one from a bundle of sticky notes set on the printer, applies printing process to the sticky note according to printing data, and sends the printed sticky note to the outside of the sticky note printer to supply the printed sticky note to a user.

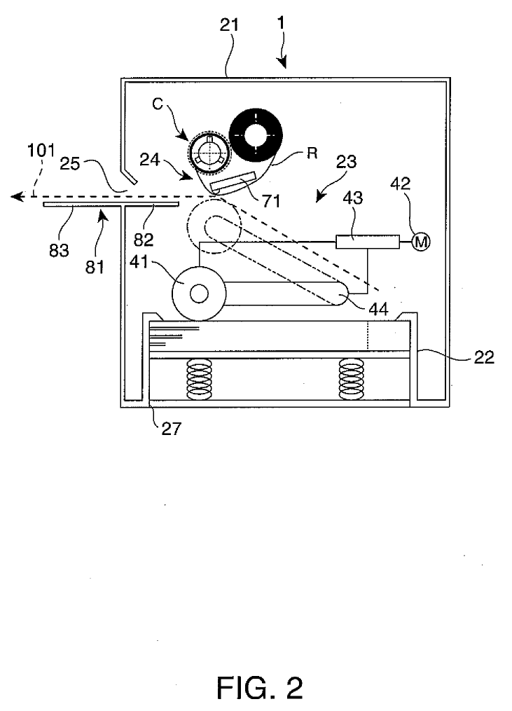

A bundle of sticky notes H have a plurality of sticky notes H1 to which adhesive is applied to a part of the back surface thereof. More specifically, the bundle of the sticky notes H are formed by laminating the plural sticky notes H1 of the shame shape (rectangular shape) and the same size. Each sticky note H1 has an adhesive portion H1a at one end of the back surface, and a free end at the other end of the back surface (see FIG. 2). The sticky note H1 is detachable from the bundle of the sticky notes H one by one, and after detached, it is re-attachable to a pocket notebook or the like by the adhesive portion H1a. A length L2 of the adhesive portion H1a of the sticky note H1 in the longitudinal direction is generally in the range from about 5 mm to about 15 mm.

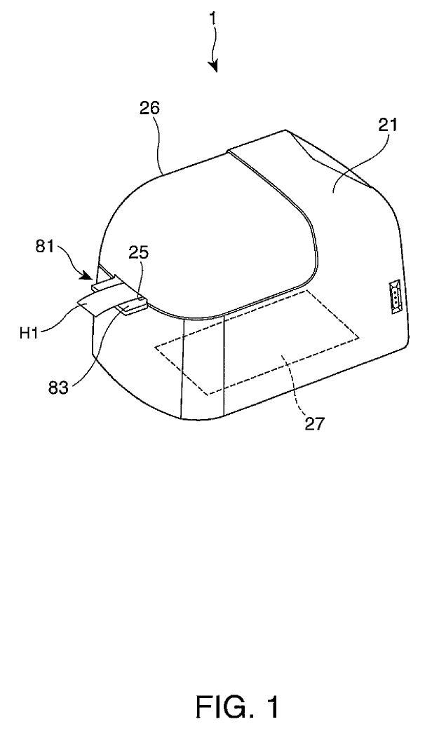

As shown in FIG. 1, a sticky note printer 1 has an external casing 21 having compact size as a whole. As shown in FIG. 2, the casing 21 contains a sticky note holder 22 on which the bundle of the sticky notes H are placed, a feeding mechanism 23 which sends the sticky note H1 separated one by one from the bundle of the sticky notes H placed on the sticky note holder 22 toward a discharge slot 25 formed on the casing 21, and a printing mechanism 24 which executes printing on the sticky note H1 being sent.

An openable and closable cover 26 is provided on the upper face of the casing 21, and this cover 26 is opened when a ribbon cartridge C containing an ink ribbon R is attached or at the time of maintenance. The casing 21 further has a sticky note attachment opening 27 through which the sticky note holder 22 can be attached and detached at the time of setting of the bundle of the sticky notes H.

The feeding mechanism 23 raises the uppermost sheet of the bundle of the sticky notes H, and sends the raised sticky note H1 along a feeding path 101 to the discharge slot 25 while separating the sticky note H1 from the bundle of the sticky notes H. While sending the sticky note H1 along the feeding path 101, the back surface of the sticky note H1 faces to below so that the free end of the sticky note H1 where the adhesive portion H1a is not provided can be exposed through the discharge slot 25. The feeding mechanism 23 includes: a feed roller 41 which contacts and raises the uppermost sticky note H1 and holds the raised sticky note H1 between the feed roller 41 and a thermal head 71 to be described later to send the sticky note H1 by rotation; a roller rotation arm 44 which shifts the feed roller 41 between a pickup position for raising the sticky note H1 and a holding position for holding the sticky note H1 between the feed roller 41 and the thermal head 71; a driving motor 42 as a driving source for the feed roller 41 and the roller rotation arm 44; and a series of reduction gear train 43 for transmitting the driving force of the driving motor 42 to the feed roller 41 and the roller rotation arm 44. The feed roller 41 is made of highly frictional material having thermal resistance such as silicone rubber, to which the adhesive portion H1a of the sticky note H1 does not adhere.

The printing mechanism 24 includes: the thermal head 71 disposed in the vicinity of the discharge slot 25 on the upstream side in such a condition as to face the feeding path 101 from above; and a ribbon winding mechanism (not shown) for winding the ink ribbon R of the attached ribbon cartridge C.

The printing mechanism 24 having this structure holds the sticky note H1 and the ink ribbon R between the feed roller 41 shifted to the holding position and the thermal head 71, and carries out printing on the surface of the sticky note H1 by the heating operation of the thermal head 71 while sending the sticky note H1 and the ink ribbon R such that they can jointly travel.

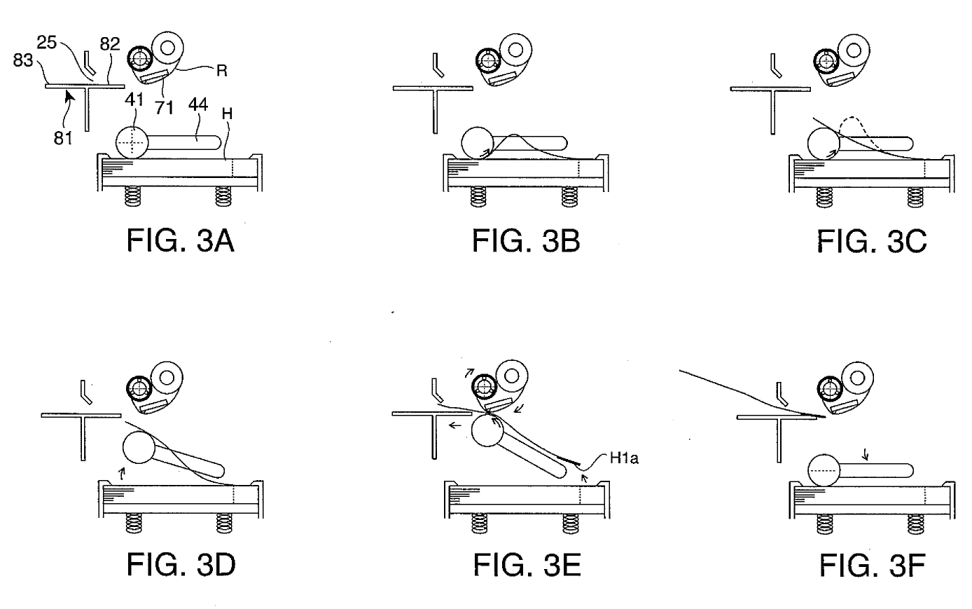

A series of operations performed from the step of raising the sticky note H1 to the step of sending out are now discussed with reference to FIGS. 3A to 3F. The feed roller 41 under the printing standby condition lies at the pickup position, contacting the surface of the uppermost sticky note H1 of the bundle of the sticky notes H set on the sticky note holder 22 (see FIG. 3A).

When receiving a printing start command from the user, the feed roller 41 rotates and starts operation of raising the sticky note H1. More specifically, the rotating feed roller 41 contacts the free end of the surface of the uppermost sticky note H1, and then the intermediate portion of the sticky note H1 in the longitudinal direction is gradually bent upward forming a curved shape (see FIG. 3B).

The rotating feed roller 41 shifts away from the bundle of the sticky notes H immediately after the free end of the rising sticky note H1 passes the lower region of the feed roller 41. At this moment, the sticky note H1 springs up to the upper side of the feed roller 41 by the rotational force of the feed roller 41. As a result, the free end of the sticky note H1 comes to ride on the feed roller 41 (see FIG. 3C).

The feed roller 41 rotating and carrying the sticky note H1 subsequently shifts to the holding position (see FIG. 3D). When the feed roller 41 reaches the holding position and holds the sticky note H1 between the feed roller 41 and the thermal head 71, the operation for feeding the ink ribbon R starts (see FIG. 3E).

The rotating feed roller 41 contacts the back face of the sticky note H1, separates the sticky note H1 from the bundle of the sticky notes H, and sends the separated sticky note H1 toward the discharge slot 25 by rotation with the free end of the sheet H1 placed as the leading end. Simultaneously with this process, the feed roller 41 performs the function of platen roller. More specifically, the feed roller 41 carries out printing on the surface of the sticky note H1 from the free end side in cooperation with the thermal head 71 while separating the adhesive portion H1a.

After completion of the sending process by the feed roller 41, the printed sticky note H1 is passed to a holding table 81 (described later) provided in the vicinity of the discharge slot 25 (see FIG. 3F). Then, the feed roller 41 shifts from the holding position to the pickup position, and finishes this operation.

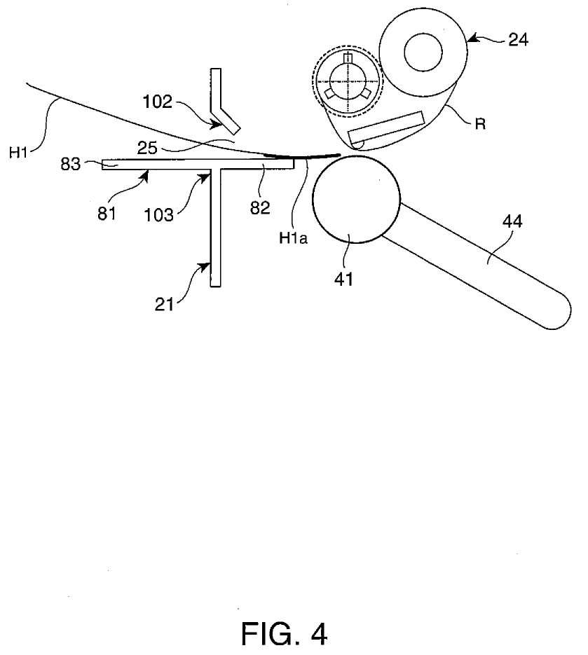

The details of the discharge slot 25 and its surroundings are now explained with reference to FIGS. 4 to 6. As shown in FIG. 4, the discharge slot 25 is an opening formed at a position horizontal to a printing position for printing on the sticky note H1, and has a slit shape. The lower end of an upper periphery 102 is bent toward the inside of the sticky note printer 1. A distance between the upper periphery 102 and a lower periphery 103 is determined such that the sticky note H1 curved by the raising operation is not caught by the discharge slot 25 and that the holding table 81 (described later) can hold a plurality of sticky notes H1.

Around the discharge slot 25, the holding table 81 is provided at the lower periphery 103 of the discharge slot 25. This holding table 81 is formed integrally with the casing 21 to hold the sticky note H1. The holding table 81 faces the feeding path 101 from below. The holding table 81 has a sticky note holding portion 82 provided inside the sticky note printer 1 at the discharge slot 25, and a sticky note receiving portion 83 provided outside the sticky note printer 1 at the discharge slot 25. The sticky note holding portion 82 is formed integrally with the sticky note receiving portion 83 such that the upper surfaces of the sticky note holding portion 82 and the sticky note receiving portion 83 are disposed on the same plane. The sticky note holding portion 82 horizontally extends inside the sticky note printer 1 from the lower periphery 103 of the discharge slot 25, and has a rectangular shape in the plan view and a plate shape. The sticky note holding portion 82 holds the sticky note H1 sent to the discharge slot 25 by using the adhesive portion H1a adhering to the upper surface of the sticky note holding portion 82. When another sticky note H1 is sent to the sticky note holding portion 82 with the preceding sticky note H1 still adhering to the sticky note holding portion 82 without removal therefrom, the subsequent sticky note H1 stacks on the preceding sticky note H1. In this case, the subsequent sticky note H1 adheres to the surface of the preceding sticky note H1, and therefore the subsequent sticky note H1 is indirectly held by the sticky note holding portion 82. It should also be noted that the sticky note holding portion 82 is not required to be formed integrally with the casing 21, though they are constructed integrally with each other in this embodiment.

Thus, the sticky note H1 exposed through the discharge slot 25 does not drop to the outside of the sticky note printer 1 but remains at the discharge slot 25 by using the sticky note holding portion 82. Since the sticky note holding portion 82 is disposed on the upstream side of the discharge slot 25, that is, inside the casing 21, the overall size of the sticky note printer 1 does not increase. In addition, the sticky note holding portion 82 functions as a guide for introducing the sticky note H1 toward the discharge slot 25. In this case, the free end of the sticky note H1 having passed through the feed roller comes to ride on the sticky note holding portion 82, and is sent to the discharge slot 25 along the sticky note holding portion 82. Thus, the sticky note H1 can be securely supplied to the discharge slot 25.

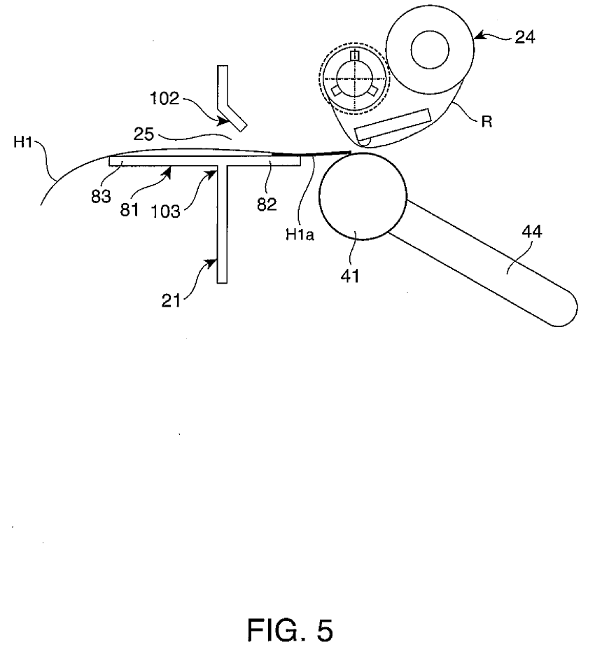

As mentioned above, the sticky note receiving portion 83 is formed integrally with the sticky note holding portion 82 such that the upper surfaces of the sticky note receiving portion 82 and the sticky note holding portion 82 are disposed on the same plane. The sticky note receiving portion 83 horizontally extends from the lower periphery 103 of the discharge slot 25 to the outside of the sticky note printer 1, and is plate-shaped and rectangular in the plan view. The separated sticky note H1 is curved by the separating operation (convex on the back face side). Thus, the free end of the sticky note H1 maintained by the adhesive portion H1a is separated to above from the sticky note receiving portion 83. However, when the adhesive force becomes weak, the free end of the sticky note H1 lowers. The sticky note receiving portion 83 receives the free end of the sticky note H1 having lowered (see FIG. 5) so as to assist the sticky note holding portion 82 in holding the sticky note H1.

Thus, the sticky note receiving portion 83 assists the sticky note holding portion 82 in holding the sticky note H1 in such a case where the sticky note H1 cannot be supported only by the sticky note holding portion 82, thereby securely preventing drop of the sticky note H1. Since the sticky note receiving portion 83 only receives the end of the sticky note H1 for holding the sticky note H1 as assistance, the sticky note receiving portion 83 need not be large-sized. Accordingly, the compactness of the overall size of the sticky note printer 1 can be maintained.

While the sticky note holding portion 82 and the sticky note receiving portion 83 are formed integrally with each other in this embodiment, these components are not required to be integrally constructed. However, since the sticky note holding portion 82 and the sticky note receiving portion 83 are provided integrally with each other in this embodiment, construction of these components can be simplified. Accordingly, the production efficiency of the sticky note printer 1 improves.

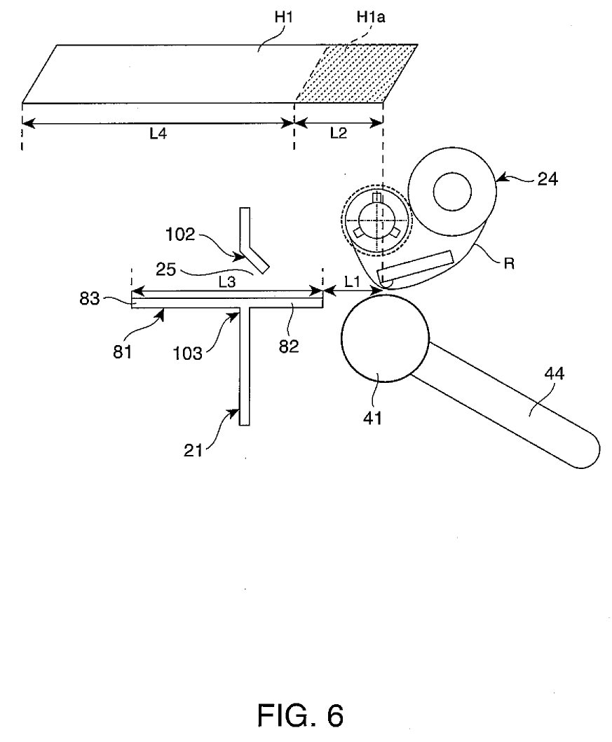

As shown in FIG. 6, the sticky note holding portion 82 and the feed roller 41 are disposed such that a length L1 between the upstream end of the sticky note holding portion 82 in the feeding direction and the position at which the rotating feed roller 41 contacts the sticky note H1 for sending the sticky note H1 at the time of supplying the sticky note H1 toward the discharge slot 25 (position for holding sticky note H1 between feed roller 41 and thermal head 71) is shorter than the length L2 of the adhesive portion H1a of the sticky note H1 in the feeding direction. Thus, the adhesive portion H1a of the sticky note H1 always reaches the sticky note holding portion 82 by the time when the feed roller 41 completes sending of the sticky note H1. Accordingly, the sticky note holding portion 82 securely holds the sticky note H1 by the adhesion of the adhesive portion H1a.

Moreover, the holding table 81 is provided such that a length L3 between the upstream end of the sticky note holding portion 82 in the feeding direction and the downstream end of the sticky note receiving portion 83 in the feeding direction (entire length of holding table 81 in the feeding direction) is shorter than a length L4 as a length obtained by subtracting the length of the adhesive portion H1a from the entire length of the sticky note H1 in the feeding direction. Thus, the free end of the sticky note H1 held by the sticky note holding portion 82 projects from the downstream end of the sticky note receiving portion 83 to the downstream side (see FIG. 4). Accordingly, the user can easily pick up the sticky note H1 held in this condition, and can easily take out the sticky note H1 from the discharge slot 25.

According to this structure, the sticky note H1 sent to the discharge slot 25 adheres to the sticky note holding portion 82 by the adhesion of the adhesive portion H1a. When another sticky note H1 adhering to the sticky note holding portion 82 already exists, the subsequent sticky note H1 supplied to the discharge slot 25 adheres to the surface of the sticky note H1 already adhering to the sticky note holding portion 82. Thus, the sticky note H1 exposed through the discharge slot 25 does not drop to the outside of the printer 1 but remains at the discharge slot 25 without necessity for providing the sticky note receiving portion 83 outside the discharge slot 25. Furthermore, since the sticky note holding portion 82 is disposed on the upstream side of the discharge slot 25, that is, inside the casing 21, the entire size of the printer 1 does not increase.

What is claimed is:

1. A sticky note feeder, comprising:
a casing;
a discharge slot provided on the casing, to which slot a sticky note having an adhesive portion at one end of the back surface is sent;
a feeding unit which sends the sticky note to the discharge slot along a feeding path; and
a sticky note holding portion which holds the sticky note sent by the feeding unit such that the back face of the sticky note faces to below and that the end of the sticky note where the adhesive portion is not provided is exposed through the discharge slot,
wherein the sticky note holding portion is disposed on the upstream side of the discharge slot in the feeding direction at such a position as to face the feeding path from below.

2. The sticky note feeder according to claim 1, wherein:
the feeding unit has a feed roller which faces the feeding path and contacts the sticky note while rotating to send the sticky note; and
a distance between the feed roller and the sticky note holding portion is shorter than the length of the adhesive portion in the feeding direction.

3. The sticky note feeder according to claim 1, wherein the discharge slot has a sticky note receiving portion on the downstream side in the feeding direction such that the sticky note receiving portion extends to the outside of the casing.

4. The sticky note feeder according to claim 3, wherein the combined length of the sticky note holding portion and the sticky note receiving portion is shorter than the length obtained by subtracting the length of the adhesive portion from the entire length of the sticky note in the feeding direction.

5. The sticky note feeder according to claim 3, wherein the sticky note holding portion and the sticky note receiving portion are formed integrally with each other.

6. A sticky note printer, comprising:
the sticky note feeder according to claim 1; and
a printing unit which executes printing on the surface of the sticky note sent by the feeding unit.
